(19) United States
(12) Patent Application Publication
(10) Pub. No.: US 2016/0278307 A1
(43) Pub. Date: Sep. 29, 2016

(54) DEVICE FOR PROPPING A TREE

(71) Applicant: TUTEURFACILE.COM, Saint Etienne de Tulmont (FR)

(72) Inventors: Julien Begassat, Saint Etienne De Tulmont (FR); Francis Delpech, Albias (FR)

(73) Assignee: TUTEURFACILE.COM, Saint Etienne De Tulmont (FR)

(21) Appl. No.: 15/035,734

(22) PCT Filed: Nov. 7, 2014
(86) PCT No.: PCT/EP2014/074079

§ 371 Date: May 10, 2016

(30) Foreign Application Priority Data
Nov. 12, 2013 (FR) 1360996

(51) Int. Cl. A01G 17/14; A01G 17/16

(52) U.S. Cl. CPC A01G 17/14; A01G 17/16

(57) ABSTRACT

A device for propping a tree includes at least one prop for propping said tree. The at least one prop includes a first element arranged to be at least partially pushed into the ground, a second element arranged to be connected to the trunk of the tree, and means for linking the first element and the second element to allow the articulation of the second element relative to the first element.

### FIELD OF ART

The present invention relates to the field of propping plants, and more particularly relates to a device for propping a tree.

### BACKGROUND

It is common to plant trees in gardens or along roads. Such trees are generally exposed to the climate of the location where they are planted, and in particular wind.

In order to prevent a tree from having its branches broken or its roots pulled out by the wind, it is known to use a frame including one or more props in order to keep it substantially vertical.

These props, of which there are generally three or four, assume the form of wooden posts or poles planted substantially vertically in the ground around the trunk of the tree and connected thereto and to one another by straps or ropes.

Each post must be pushed into the ground at a relatively significant depth, for example at least 30 or 40 centimeters, which requires an even greater effort when the length and diameter of the post are large. For example, ordinarily, posts are used with a length from a meter and a half to two meters and with a diameter of five to ten centimeters.

In such a case, it is necessary to use a scaffolding or stepladder so as to place oneself above the substantially vertical post and push it down using forcible blows. Furthermore, at least two operators are needed: a first operator to hold the post substantially vertical while the second operator pushes it into the ground using hammer blows. The pushing in of each post is therefore disadvantageously difficult, time-consuming and labor-intensive.

### SUMMARY

The invention aims to resolve at least some of the drawbacks of the existing solutions by proposing a device for propping a tree that is both solid and reliable, and that is quick and easy to install.

To that end, the invention relates to a device for propping a tree comprising at least one prop for propping said tree, said device being remarkable in that said prop comprises:
a first element arranged to be at least partially pushed into the ground,
a second element arranged to be connected to the tree trunk, and
means for linking the first element and the second element (first linking means), configured to allow the articulation of the second element relative to the first element, in particular when the first element is pushed or maintained in the ground.

“Connected to the tree trunk” means that the second element is configured to bear on the trunk, or that the second element is configured to be connected to the trunk by second linking means, for example string.

The device according to the invention is particularly advantageous inasmuch as it suffices for an operator first to push the first element at least partially into the ground, the second element being bent relative to the first element owing to the linking means, then to straighten the second element to place it in a position propping the tree. It is in fact easier to push the first element into the ground than to push in a prop having a length equal to the sum of the lengths of the first element and the second element.

The device according to the invention can thus be installed in several minutes by a single operator and is able to be used on sloping ground. It further has great resistance to bad weather and offers the tree considerable stability, even in case of high winds, which makes it possible to guarantee straight growth of the tree. The device according to the invention may further be adapted to the height and/or diameter of the tree by modifying the distance between the trunk and the stakes.

Preferably, the linking means comprise a pivot link. Such a link may for example be made using a screw and nut system or an axle around which the two elements of the prop can pivot. The screws, nut, axle may be made from metal or any other material, for example a plastic, composite, wood, etc.

According to one feature of the invention, the first element assumes the form of a stake comprising a free end arranged to be pushed into the ground and a linking end connected to the second element by the linking means.

Advantageously, the free end of the stake is pointed so as to be easily pushed into the ground.

Also advantageously, the linking end comprises a striking face, preferably substantially planar, arranged to be struck, for example by hammer blows, so as to push the stake into the ground.

According to another feature of the invention, the second element assumes the form of a pole, an arm or a post.

According to one aspect of the invention, the second element comprises a free end and a linking end connected to the first element by the linking means.

Preferably, the ratio of the lengths of the first element and the second element is comprised between 0.25 and 0.5. This makes it possible to have a first element that is shorter and therefore easier to push into the ground, and a second element that is longer so as to better prop the tree. Preferably, the length of the first element is comprised between 20 cm and 60 cm, and the length of the pole is comprised between 40 cm and 240 cm.

Advantageously, the prop comprises means for blocking the linking means of the first element and the second element making it possible to block the articulation, and thus to secure the first element and the second element. The blocking of the link between the first element and the second element makes it possible to make the device solid and static, and thus improves the quality of the prop for the tree.

In one preferred embodiment of the device according to the invention, the free end of the second element is arranged to bear against the tree trunk.

The free end of the second element may, for example, comprise a beveled portion, for example at an angle comprised between 30° and 60°, preferably about 45°, and arranged to bear against the tree trunk. The tree can thus be propped effectively.

According to another feature of the invention, the device comprises second linking means arranged to connect the free end of the second element to the tree trunk.

Such second linking means may for example assume the form of one or more straps or one or more strings that are easy to link the trunk.

If the free end of the second element bears on the trunk of the tree, the second linking means can make it possible to keep the second element pressed against the trunk. For example, an elastic strap may be wound around the trunk and the free end of the second element so as to keep it pressed against the trunk. Advantageously, the second linking means may, before being wound around the free end of the second element, further be wound around the trunk first so as to be inserted between the trunk and the device in order to protect the trunk from friction from the free end of the second element.

The elasticity of the second linking means makes it possible to prevent these means from hindering the development of the tree, which can thus easily grow and become larger while also being propped.

Preferably, the device comprises three props so as to form a tripod around the tree trunk. Such a tripod gives the device great stability and allows the tree to withstand strong winds.

The invention also relates to a method for installing a prop device as previously described, said method being remarkable in that it comprises:
a step of pushing at least part of the first element of the prop into the ground,
a step of tilting the second element of the prop into a usage position connected to the tree trunk.

According to one aspect of the invention, the tilting of the second element of the prop is done until the second element bears against the tree trunk.

Alternatively, the tilting of the second element of the prop is done until the second element is substantially vertical. “Substantially vertical” means that the longitudinal axis extends in a direction forming an angle of plus or minus ten degrees with the vertical.

In this case, the second element may next be connected to the tree trunk by second linking means.

Advantageously, when the device comprises means for blocking the linking means of the first element and of the second element, the method comprises a step of blocking said linking means, such that the second element is substantially vertical.

The method may further comprise a step of positioning second linking means of the device on the tree trunk.

Other features and advantages of the invention will appear in the following description, done in reference to the appended figures provided as non-limiting examples and in which identical references are given to similar objects.

### BRIEF DESCRIPTION OF THE DRAWINGS

FIG. 1 illustrates one embodiment of the device according to the invention comprising three props.

FIG. 2 illustrates a prop of the device of FIG. 1.

FIG. 3 is a partial view of the articulation and the linking means of the prop of FIG. 2.

FIGS. 4 and 5 diagrammatically illustrate one embodiment of the method according to the invention.

### DETAILED DESCRIPTION

### I) Description of the System According to the Invention

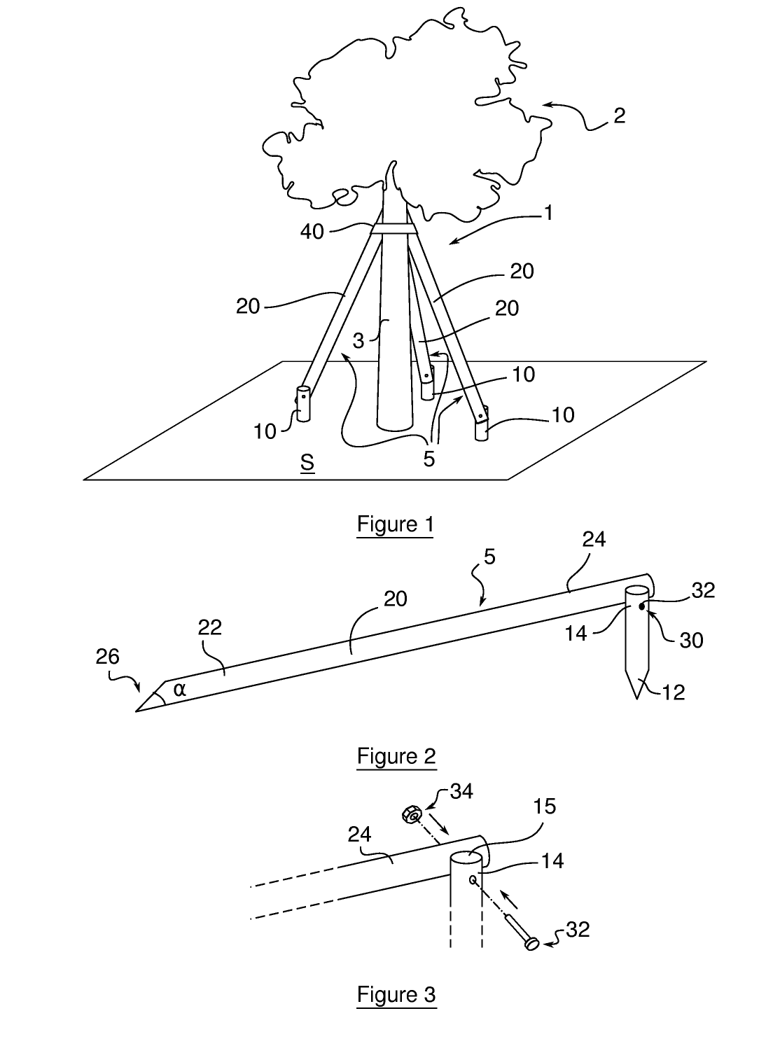

FIG. 1 illustrates a device 1 for propping a tree 2 planted in the ground S. The illustrated embodiment of the propping device according to the invention comprises three props 5 for maintaining said tree 2.

In this example, the trunk 3 of the tree 2 is kept in a substantially vertical position. “Substantially vertical” here means that the longitudinal axis of the trunk 3 of the tree 2 extends in a direction forming an angle of plus or minus ten degrees with the vertical.

According to the invention, each prop 5 comprises a first element 10, a second element 20, linking means 30 (in reference to FIG. 2) of the first element 10 and the second element 20, and second linking means 40 for connecting the second element 20 to the trunk 3.

### a) First Element 10

The first element 10 is arranged to be pushed at least partially into the ground S.

As illustrated in FIG. 2, the first element assumes the form of a stake 10, for example made from wood, metal, plastic or a composite material, comprising a pointed free end 12 so as to be easily pushed into the ground S and a linking end 14 connected to the second element 20 by the linking means 30.

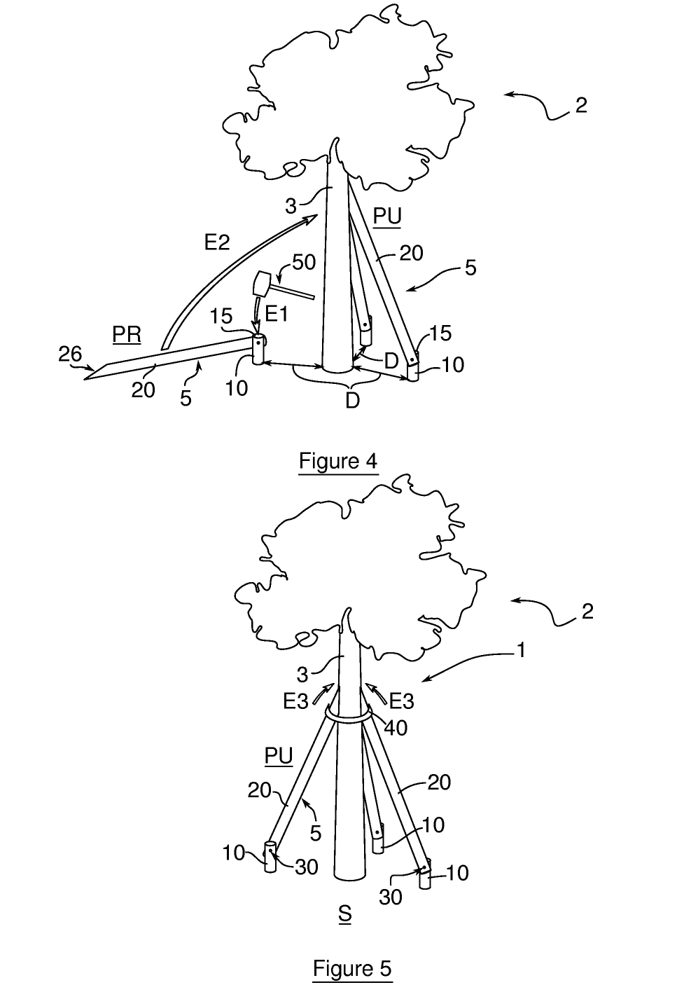

The linking end 14 comprises a substantially planar striking face 15 (in reference to FIG. 3), arranged to be struck, for example by hammer blows 50 (in reference to FIG. 4), so as to push the stake 10 into the ground S.

### b) Second Element 20

The second element 20 is arranged to be connected to the trunk 3 of the tree 2.

In this example, still in reference to FIG. 2, the second element assumes the form of a pole or post 20, for example made from wood, metal, plastic or a composite material, comprising a free end 22 and a linking end 24 connected to the first element 10 by the linking means 30.

In the embodiment of the device according to the invention illustrated in the figures, the free end 22 of the pole 20 is arranged to bear against the trunk 3 of the tree 2, and to that end comprises a beveled portion 26 with an angle α for example comprised between 30° and 60°, preferably approximately equal to 45°.

The ratio of the lengths of the first element 10 and the second element 20 is advantageously comprised between 0.25 and 0.5.

For example, the length of the stake 10 may be comprised between 20 cm and 60 cm, and the length of the pole 20 may be comprised between 40 cm and 240 cm.

### c) Linking Means 30

The linking means 30 for connecting the stake 10 and the pole 20 are configured to allow the articulation of the pole 20 relative to the stake 10, in particular when the stake 10 is pushed into the ground S.

In reference to FIGS. 2 and 3, the linking means 30 assume the form of a pivot link made by a screw 32 and nut 34 system. Of course, any other linking means allowing the articulation of the pole 20 relative to the stake 10 may be used, for example an axle, one or more ball joints, sliding means, etc.

The device 1 may comprise blocking means for the linking means 30 of the stake 10 and the pole 20.

In this example, the screw 32 and nut 34 system makes up such blocking means when the nut 34 is tightened so as to block the rotation of the pole 20 relative to the stake 10.

Of course, alternatively, any blocking means, for example a notch or a ring, may be used.

### d) Second Linking Means 40

In the illustrated embodiment, in reference to FIGS. 1 and 5, the device 1 comprises second linking means 40 for connecting the free end 22 of the pole 20 of each prop 5 to the trunk 3 of the tree 2, which make it possible to keep the poles 20 pressed against the trunk 3 of the tree 2.

These second linking means here assume the form of a strap 40, for example elastic, wound around the free ends 22 of the poles 20 of the props 5 when the latter bear against the trunk 3 of the tree 2.

The free ends 22 of the poles 20 may comprise a protuberance (not shown), for example a pilot point or a lug, extending transversely and protruding and the strap 40 may comprise orifices (not shown) so as to fasten the strap 40 on said protuberance.

In order to protect the trunk 3 from rubbing by the props 5, the strap 40 can first be wound around the trunk 3 before pressing the free ends 22 of the poles 20 against the trunk 3, the strap then constituting an intermediate element between the poles 20 and the trunk 3, then winding the strap 40 around the free ends 22 of the poles 20 and attaching it on at least one of the protuberances of a free end 22 of a pole 20.

### II) Description of One Exemplary Embodiment of the Device Previously Described

The implementation of the device 1 is described below in reference to FIGS. 4 and 5.

In order to install the device 1, the stakes 10 of each prop 5 are positioned around the tree 1 substantially at the vertical, preferably equidistantly D from the trunk 3, with free ends 12 pointed toward the ground S.

In step E1, the stake 10 of each prop 5 is then partially pushed into the ground by hammer blows 50 applied on the striking face 15 of the stake 10.

The pole 20 of each prop 5 then rests on the ground S in its bent position PR.

The pole 20 of each prop 5 is then tilted, in step E2, until the beveled portion 26 of the free ends 22 of the poles 20 comes into contact with the trunk 3 in a usage position PU of the prop 5.

Preferably, the pole 20 is already mounted on the stake 10 of each prop 5 by the screw and nut system 30 and can tilt from the bent position PR to the usage position PU around the pivot link formed by the screw 32 and the nut 34 when the latter is loosened.

Alternatively, the stakes 10 can first be planted in the ground S, then each pole 20 can next be mounted on each stake 10 with the screw 32 and nut 34 system bearing against the trunk 3 of the tree 2.

For each prop 5, the nut 34 is then tightened on the screw 32 so as to secure the stake 10 planted in the ground S and the pole 20 bearing against the trunk 3 of the tree 2 via said beveled portion 26.

A strap 40 is next wound around the free ends 22 of the poles 20 thus positioned so as to keep them bearing on the trunk 3 in order to prop the tree.

The device according to the invention is particularly advantageous inasmuch as it can be installed in a few minutes by a single operator.

The device is also suitable for being used on sloping ground.

It also has high resistance to bad weather and offers the tree great stability even in case of strong winds, which makes it possible to guarantee straight growth of the tree.

The device according to the invention can also be adapted to the height and/or diameter of the tree by modifying the distance between the trunk and the stakes.

1. A device for propping a tree, the device comprising at least one prop for propping said tree, the at least one prop comprising:
a first element arranged to be at least partially pushed into a ground;
a second element arranged to be connected to a trunk of the tree; and
means for linking the first element and the second element to allow articulation of the second element relative to the first element.

2. The device according to claim 1, wherein the linking means comprise a pivot link.

3. The device according to claim 1, wherein the first element is a stake comprising a free end arranged to be pushed into the ground and a linking end connected to the second element by the linking means.

4. The device according to claim 3, wherein the linking end comprises a striking face arranged to be struck so as to push the stake into the ground.

5. The device according to claim 1, wherein the second element comprises a free end and a linking end connected to the first element by the linking means.

6. The device according to claim 5, wherein the free end of the second element comprises a beveled portion arranged to bear against the trunk of the tree.

7. The device according to claim 1, wherein the ratio of lengths of the first element and the second element is approximately between 0.25 and 0.5.

8. The device according to claim 1, further comprising second linking means for connecting the second element on the trunk of the tree.

9. The device according to claim 1, said at least one prop comprises three props so as to form a tripod around the trunk the tree.

10. A method for installing a prop device, the prop device comprising a first element arranged to be at least partially pushed into the ground, a second element arranged to be connected to a trunk of the tree, and means for linking the first element and the second element, and configured to allow articulation of the second element relative to the first element, said method comprising:
pushing at least part of the first element of the prop into the ground; and
tilting the second element of the prop a usage position in which the free end of the second element is bearing against the trunk of the tree.

11. The method according to claim 10, wherein the linking means comprise a pivot link.

12. The method according to claim 10, wherein the first element is a stake comprising a free end arranged to be pushed into the ground and a linking end connected to the second element by the linking means.

13. The method according to claim 12, wherein the linking end comprises a striking face arranged to be struck so as to push the stake into the ground.

14. The method according to claim 10, wherein the second element comprises a free end and a linking end connected to the first element by the linking means.

15. The method according to claim 14, wherein the free end of the second element comprises a beveled portion arranged to bear against the trunk of the tree.

16. The method according to claim 10, wherein the ratio of lengths of the first element and the second element is approximately between 0.25 and 0.5.

17. The method according to claim 10, further comprising second linking means for connecting the second element on the trunk of the tree.

18. The method according to claim 10, said at least one prop comprises three props so as to form a tripod around the trunk of the tree.
